(19) United States
(12) Patent Application Publication
(10) Pub. No.: US 2017/0306563 A1
(43) Pub. Date: Oct. 26, 2017

(54) FINE FIBER PULP FROM SPINNING AND WET LAID FILTER MEDIA

(71) Applicants: Vishal Bansal, Lee's Summit, MO (US); Thomas D. Carr, Franklin, TN (US); Yogesh Ner, Spring Hill, TN (US); Kaiyi Liu, Spring Hill, TN (US); Stephen R. Kay, Austin, TX (US)

(72) Inventors: Vishal Bansal, Lee's Summit, MO (US); Thomas D. Carr, Franklin, TN (US); Yogesh Ner, Spring Hill, TN (US); Kaiyi Liu, Spring Hill, TN (US); Stephen R. Kay, Austin, TX (US)

(73) Assignee: CLARCOR Inc., Franklin, TN (US)

(21) Appl. No.: 15/490,707

(22) Filed: Apr. 18, 2017

Related U.S. Application Data
(60) Provisional application No. 62/324,937, filed on Apr. 20, 2016.

(51) Int. Cl. D21H 13/26; C08J 5/18; D21H 13/14; D21H 13/20; D21H 13/06; D04H 1/724; D01D 5/088; D01D 4/02; D21H 13/24; D21H 13/12

(52) U.S. Cl. CPC D21H 13/26; D21H 13/24; C08J 5/18; D21H 13/14; D21H 13/12; D21H 13/06; D04H 1/724; D01D 5/088; D01D 4/025; D21H 13/20; C08J 2377/00; C08J 2367/00; C08J 2327/18; C08J 2327/16; C08J 2323/12; C08J 2301/12; C08J 2381/02

(57) ABSTRACT

A material comprising a fine fiber pulp is provided. The fine fiber pulp has a plurality of fine fibers have an average diameter of less than 1 micron and an average length of less than 1 millimeter. In embodiments, the fine fibers formed of a polymer. The material can be created according to a method in which the fine fiber strands are formed from a polymer melt or a polymer solution, the fine fiber strands are cooled to a temperature of less than −25° C. to increase brittleness of the fine fibers, and the fine fiber strands are granulated into the fine fiber pulp.

### CROSS-REFERENCE TO RELATED PATENT APPLICATIONS

This patent application claims the benefit of U.S. Provisional Patent Application No. 62/324,937, filed Apr. 20, 2016, the entire teachings and disclosure of which are incorporated herein by reference thereto.

### FIELD OF THE INVENTION

This invention generally relates to a material incorporating a fine fiber pulp, and more particularly, this invention relates to a method for creating a fine fiber pulp that can be utilized as a filler material in a variety of applications.

### BACKGROUND OF THE INVENTION

Methods of and apparatuses for producing nanofibers are known by way of centrifugal spinning. Exemplary disclosures include U.S. Publication Nos. 2016/0083867, 2016/0069000, 2015/0013141, 2014/0339717, 2014/0217629, 2014/0217628, 2014/0159262, 2014/0042651, 2014/035179, 2014/0035178, 2014/0035177, 2012/0295021, and 2012/0294966 and U.S. Pat. Nos. 9,181,635; 8,778,240; 8,709,309; 8,647,541; and 8,647,540. These entire disclosures are incorporated in their entireties herein by reference. As such, centrifugal spinning, spinnerets, materials, and methods disclosed in these references are preferred for use in an embodiment of the present invention that provides for improvements and new uses for such centrifugal spinning systems.

### BRIEF SUMMARY OF THE INVENTION

The inventive aspects and embodiments discussed below in the following separate paragraphs of the summary may be used independently or in combination with each other.

In one aspect, a material comprising a fine fiber pulp is provided. The fine fiber pulp has a plurality of fine fibers have an average diameter of less than 5 microns and an average length of less than 1 millimeter. In embodiments, the fine fibers formed of a polymer.

In certain embodiments, the fine fibers can be formed from at least one of electrospinning and centrifugal spinning.

The polymer from which the material is made is preferably selected from the group consisting of polyester, polypropylene, cellulose acetate, polyphenylene sulfide, polyamides (nylons), polytetrafluoroethylene, polyvinylidene fluoride, and other fluoropolymer.

In another aspect, a method of forming the material is provided. The method includes the steps of forming fine fiber strand from a polymer melt or a polymer solution; cooling the fine fiber strands to a temperature of less than −25° C. to increase brittleness of the fine fibers; and granulating the fine fiber strands into the fine fiber pulp.

In a particular embodiment, the step of forming the fine fiber strands is accomplished via centrifugal spinning, wherein centrifugal spinning involves centrifugally expelling a liquid polymer that comprises at least one of polymer melt or polymer solution, through orifices in at least one spinneret while rotating the spinneret at a speed of at least 2500 rpms. Centrifugal spinning further involves drawing down a fiber diameter of the fine fibers through centrifugal force and in the absence of electrospinning forces, i.e., no electrospinning forces are used to draw down the fiber diameter.

In a certain embodiment, during the step of forming the fine fiber strands, the fine fiber strands have a length greater than 1 millimeter and an average diameter of less than 1 micron.

In a preferred embodiment, the cooling and granulating steps are accomplished through at least one of cryogenic grinding or cryogenic milling.

During the step of forming the fine fiber strands, a sheet of the fine fiber strands may be created in a fibrous web entanglement. The sheet may be run through a cryogenic grinder or a cryogenic mill.

In some applications, the fine fiber pulp may be used as a high surface area filler in at least one of: a rigid plastic, a paints, fiber pulp, and filler in coatings.

In a further aspect, the material formed from the fine fiber strands can be formed into a wet laid sheet structure. The wet laid structure may include the fine fiber pulp blended along with cellulose fibers or other wet laid fibers, such that the fiber pulp and the cellulose fibers or other wet laid fibers being bound together in the wet laid sheet from a wet laid process.

In still another aspect, the material formed from the fine fiber strands can be formed into a film. In such embodiments, the fine fiber pulp may be mixed and formed with a polymer into a transparent plastic film.

The fine fiber pulp can provide UV protection in the transparent plastic film while maintaining transparency of the film.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic depiction of a manufacturing line (not to scale) for creating a fine fiber pulp according to an exemplary embodiment of the present invention;

FIG. 2 depicts a spinneret for centrifugal spinning of the nanofibers in the deposition chamber of the manufacturing line of FIG. 1; and

FIG. 3 is a schematic depiction of a manufacturing line (not to scale) for creating a wet-laid product from the fine fiber pulp produced, for example, from the manufacturing line depicted in FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

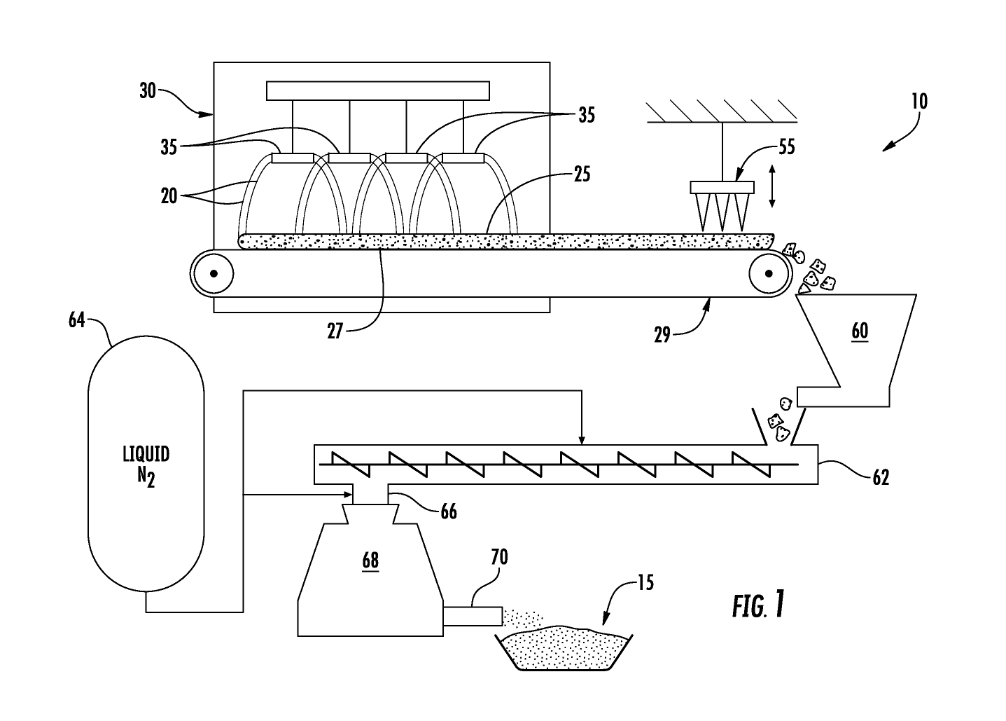

FIG. 1 depicts an exemplary, schematic embodiment of a manufacturing line 10 for creating a fine fiber pulp 15.

As shown in FIG. 1, initially, fine fibers 20 are formed into a sheet 25 in a fiber deposition chamber 30. The fine fibers 20 are preferably produced via centrifugal spinning (also referred to herein as “Forcespinning®”) and deposited on a moving substrate 27. The moving substrate 27 can be incorporated into the sheet 25, such as with a scrim material, or the moving substrate can be separate from the sheet 25, such as a conveyor system 29 (as depicted in FIG. 1).

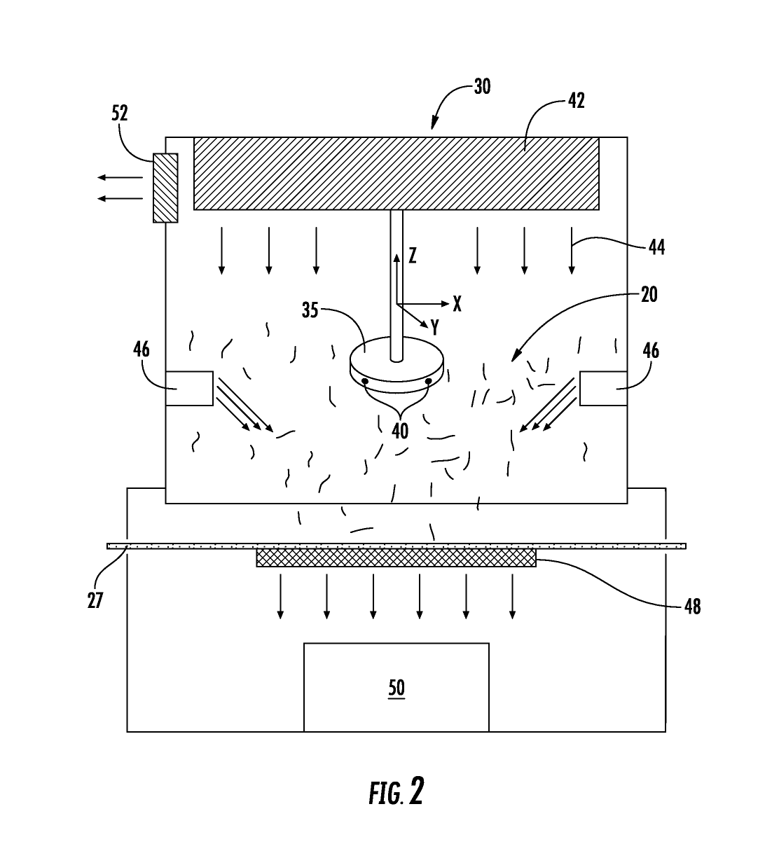

FIG. 2 depicts a more detailed schematic view of a section of the fiber deposition chamber 30. As depicted in FIGS. 1 and 2, the deposition chamber 30 is a Forcespinning® chamber. Forcespinning® involves centrifugally expelling a liquid polymer (i.e., at least one of a polymer melt or polymer solution) through orifices 40 in at least one spinneret 35 while rotating the spinneret 35 at a speed of at least 2500 rpms. This centrifugal action results in the drawing down of the fiber diameter of the fine fibers. It should be noted that the Forcespinning® action draws down the diameter of the fine fibers 20 without the use of electrospinning forces to draw down the diameter of the fine fibers 20.

The deposition chamber 30 of FIG. 2 depicts a single spinneret 35, but more spinnerets 35 can be included in the deposition chamber 30, such as shown in FIG. 1, depending on the amount of fine fibers 20 needed. The spinnerets 35 typically are capable of moving in the X, Y, and Z planes to provide a range of coverage options for producing the sheet 25. Each spinneret 35 features a plurality of orifices 40 through which the fine fibers 20 are expelled. The orifices 40 can each be connected to the same reservoir of polymer melt, polymer solution, or liquid adhesive, or each orifice 40 can be connected to a different reservoir of polymer melt, polymer solution, or liquid adhesive. Moreover, in embodiments with multiple spinnerets 35, each spinneret 35 can expel a different polymer melt, polymer solution, or liquid adhesive. During fine fiber deposition, the spinnerets 35 will rotate at least at 2500 rpms. More typically, the spinnerets 35 will rotate at least at 5000 rpms.

Using the spinnerets 35, the fine fibers 20 can be created using, for example, a solution spinning method or a melt spinning method. A polymer melt can be formed, for example, by melting a polymer or a polymer solution may be formed by dissolving a polymer in a solvent. Polymer melts and/or polymer solutions as used herein also refers to the material formed from heating the polymer to a temperature below the melting point and then dissolving the polymer in a solvent, i.e., creating a “polymer melt solution.” The polymer solution may further be designed to achieve a desired viscosity, or a surfactant may be added to improve flow, or a plasticizer may be added to soften a rigid fiber, or an ionic compound may be added to improve solution conductivity. The polymer melt can additionally contain polymer additives, such as antioxidant or colorants.

Several optional features of the deposition chamber 30 are depicted in FIG. 2. Generally, the fine fibers 20 are preferably continuous fibers (though the fine fibers 20 are depicted schematically as short fibers in FIG. 2). The fine fibers 20 can be encouraged downwardly to collect on the moving substrate 27 through a variety of mechanisms that can work independently or in conjunction with each other. For example, in some embodiments, a gas flow system 42 can be provided to induce a downward gas flow, depicted with arrows 44. The gas flow system 42 can also include lateral gas flow jets 46 that can be controlled to direct gas flow in different directions within the deposition chamber 30. Additionally, in some embodiments, formation of the fine fibers 20 will induce an electrostatic charge, either positive or negative, in the fiber. This electrostatic charge is not used to draw the fiber to the desired thickness such as in electrospinning. Nevertheless, an electrostatic plate 48 can be used to attract the charged fibers 20 downwardly to the moving substrate 27. Thus, as can be seen in FIG. 2, the electrostatic plate 48 is located below the moving substrate 27. Furthermore, in some embodiments, a vacuum system 50 is provided at the bottom of the deposition chamber 30 to further encourage the fine fibers 20 to collect on the moving substrate 27. Still further, in some embodiments, an outlet fan 52 is provided to evacuate any gasses that may develop, such as might develop as the result of solvent evaporation or material gasification, during the Forcespinning® process.

In other embodiments, the fine fiber 20 can be deposited using a different method than Forcespinning® or in conjunction with Forcespinning®. For example, in one embodiment, the fine fiber 20 can be produced via electrospinning.

The fine fiber strands 20 that are incorporated into the sheet 25 have a length greater than 1 millimeter and an average diameter of less than 1 micron. More preferably, the fine fiber strands 20 have a length greater than 10 cm, and most preferably, the fine fiber strands 20 have a length greater than 1 meter (i.e., continuous strands).

The Forcespinning® of the fine fiber strands 20, especially the continuous strands, entangles the fine fibers 20 with each other to form the sheet 25.

After exiting the fiber deposition chamber 30, the sheet is can be chopped at a chopping station 55 to reduce the length of the fine fibers 20 before the sheet 25 is fed into a hopper 60 of a screw conveyer 62. A tank 64 of cryogenic fluid, such as liquid nitrogen, supplies cryogenic fluid to the screw conveyer 62 to chill the sheet 25 so as to increase the brittleness of the sheet 25. As depicted in FIG. 1, the cryogenic fluid is supplied to both the screw conveyer 62 and to an outlet 66 of the screw conveyor 62 in order to drop the temperature of the sheet 25 to the desired level.

Preferably, temperature of the sheet is dropped below −25° C. More preferably, the sheet 25 is chilled to a temperature below −40° C., and most preferably, the sheet 25 is chilled to a temperature below −50° C. In other embodiments, the sheet 25 can be chilled using dry ice or liquid carbon dioxide instead of or in addition to liquid nitrogen.

While cooling the sheet 25, the screw conveyer 62 transports the sheet 25 to a cryogenic mill or grinder 68. The cryogenic mill 68 can be any of a variety of suitable cryogenic mills, including inter alia pin mills and sieve mills. The cryogenic mill 68 granulates the sheet 25 to form the fine fiber pulp 15, which is collected at an outlet 70 of the cryogenic mill 68.

Alternatively, the sheet 25 can be fed directly into the cryogenic mill 68, bypassing the chopping station 55 and the screw conveyor 62. In such instances, the sheet 25 is preferably cooled on the conveyor system 29 prior to entering the cryogenic mill 68.

The sheet 25 is granulated into a plurality of fine fibers that make up the pump 15 have an average diameter of less than 1 micron and an average length of less than 1 millimeter. More preferably, the fine fibers making up the pulp 15 have an average diameter between 0.3 and 0.8 microns and a length less than 1 millimeter. Most preferably, the fine fibers that make up the pulp 15 have a length between 0.5 and 1 millimeter.

In embodiments, the fine fibers are preferably formed from a polymer. The polymer from which the material is made is preferably selected from the group consisting of polyester, polypropylene (PP), cellulose acetate (CA), polyphenylene sulfide (PPS), polyamides (such as Nylons), polytetrafluoroethylene (PTFE), polyvinylidene flouride (PVDF), and other fluoropolymers.

The fine fiber pulp 15 made according to the aforedescribed process can be incorporated as a high surface area filler in a variety of products including rigid plastics, paints, coatings, and cosmetics.

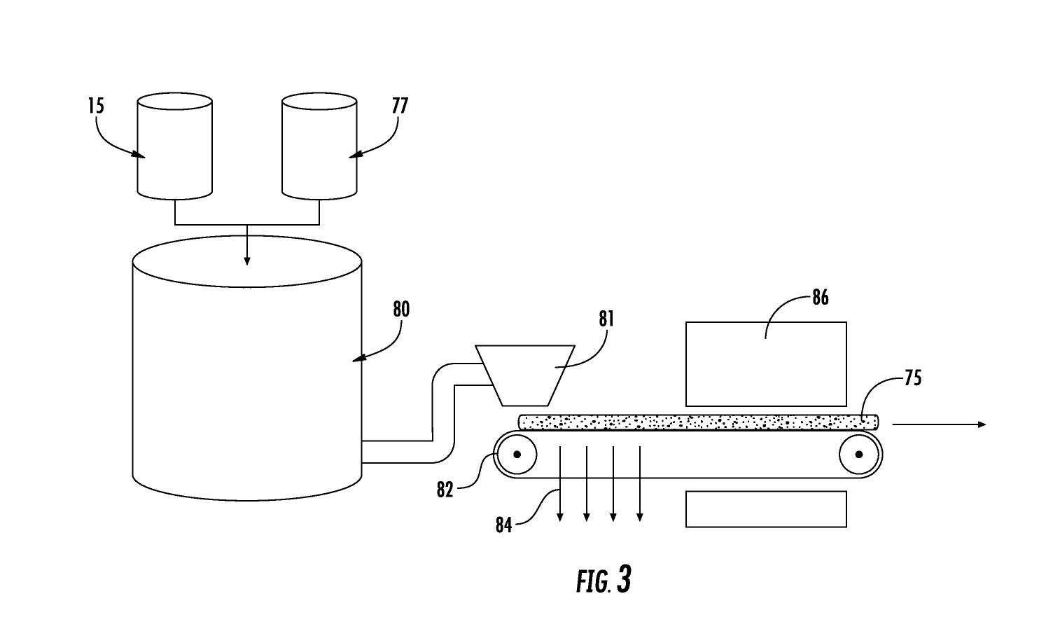

Additionally, the fine fiber pulp 15 can be formed into a wet laid sheet structure 75 as shown in FIG. 3. The wet laid structure 75 includes the fine fiber pulp 15 blended along with cellulose fibers 77 (or other wet laid fibers) in water (or another solvent) in order to form a slurry 80. The slurry 80 is deposited through a deposition head 81 onto a conveyor system 82. Preferably, the conveyor system 82 features a mesh substrate such that solvent from the slurry 80 can drain through the substrate as depicted with arrows 84. The wet laid fine fiber pulp 15 and cellulose fibers 77 are then transported to an oven 86, or other drying device, so as to form the wet laid sheet structure 75. After drying, the wet laid sheet structure 75 can be further processed, such as undergoing further bonding techniques or being wound for storage or transport.

The wet laid sheet structure 75 can be used, e.g., as part of a filter element. The fine fiber pulp 15 incorporated into the wet laid sheet structure 75 can, thus, help to improve the filtration efficiency of the filter element.

Furthermore, in certain embodiments, the fine fiber pulp 15 can be formed into a film. In such embodiments, the fine fiber pulp 15 may be mixed and formed with a polymer into a transparent plastic film. The fine fiber pulp can provide such benefits as UV protection in the transparent plastic film while maintaining transparency of the film.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A material comprising: fine fiber pulp comprising a plurality of fine fibers have an average diameter of less than 1 micron and an average length of less than 1 millimeter, the fine fibers formed of a polymer.

2. The material of claim 1, wherein the fine fibers are formed from at least one of electrospinning and centrifugal spinning.

3. The material of claim 1, wherein the polymer is at least one selected from a group consisting of: polyester, polypropylene, cellulose acetate, polyphenylene sulfide, polyamide, polytetrafluoroethylene, polyvinylidene fluoride, and other fluoropolymer.

4. A method of forming the material of claim 1, comprising:
forming fine fiber strands from a polymer melt or a polymer solution;
cooling the fine fiber strands to a temperature of less than −25° C. to increase brittleness of the fine fibers;
granulating the fine fiber strands into the fine fiber pulp.

5. The method of claim 4, wherein the forming of the fine fiber strands further comprises:
centrifugal spinning the fine fibers by centrifugally expelling a liquid polymer that comprises at least one of polymer melt or polymer solution, through orifices in at least one spinneret while rotating the spinneret at a speed of at least 2500 rpms; and
drawing down a fiber diameter of the fine fibers through centrifugal force without using electrospinning forces to draw down the fiber diameter.

6. The method of claim 4, wherein the forming forms the fine fiber strands to have a length greater than 1 millimeter and an average diameter of less than 1 micron.

7. The method of claim 4, wherein the cooling and granulating comprises at least one of cryogenic grinding or cryogenic milling.

8. The method of claim 7, wherein the forming the fine fiber strands creates a sheet of the fine fiber strands in a fibrous web entanglement and running the sheet through a cryogenic grinder or a cryogenic mill.

9. A method of using the material of claim 1, comprising using the fine fiber pulp as a high surface area filler in at least one of a composite of: a rigid plastic, a paints, a fiber pulp, coatings, and cosmetics.

10. A wet laid sheet structure, including the material of claim 1, comprising: the fine fiber pulp blended along with cellulose fibers or other wet laid fibers, the fiber pulp and the cellulose fibers or other wet laid fibers being bound together in the wet laid sheet from a wet laid process.

11. A film including the material of claim 1 comprising: the fine fiber pulp being mixed and formed with a polymer into a transparent plastic film.

12. The film of claim 11, wherein the fine fiber pulp provides UV protection in the transparent plastic film while maintaining transparency of the film.
